(19) United States
(12) Patent Application Publication
(10) Pub. No.: US 2019/0130921 A1
(43) Pub. Date: May 2, 2019

(54) APPARATUSES AND METHODS FOR ENCODING AND DECODING A MULTICHANNEL AUDIO SIGNAL

(71) Applicant: Huawei Technologies Duesseldorf GmbH, Duesseldorf (DE)

(72) Inventor: Panji SETIAWAN, Munich (DE)

(21) Appl. No.: 16/232,957

(22) Filed: Dec. 26, 2018

Related U.S. Application Data
(63) Continuation of application No. PCT/EP2016/065438, filed on Jun. 30, 2016.

(51) Int. Cl. G10L 19/008; G10L 19/02; G10L 19/032

(52) U.S. Cl. CPC G10L 19/008; G10L 19/032; G10L 19/0212

(57) ABSTRACT

An apparatus and a method for encoding an input audio signal are disclosed. The input audio signal comprises a plurality of input audio channels. Metadata associated with a plurality of KLT eigenchannels allows reconstructing the plurality of input audio channels on the basis of the plurality of eigenchannels. A subset of the plurality of eigenchannels is encoded. The metadata is encoded and provided in a quantized form. The plurality of input audio channels is transformed into the plurality of eigenchannels on the basis of the metadata in the quantized form.

### CROSS-REFERENCE TO RELATED APPLICATIONS

This application is a continuation of International Application No. PCT/EP2016/065438, filed on Jun. 30, 2016, the disclosure of which is hereby incorporated by reference in its entirety.

### TECHNICAL FIELD

The invention relates to the field of audio signal processing. More specifically, the invention relates to apparatuses and methods for encoding and decoding a multichannel audio signal on the basis of the Karhunen-Loève Transform (KLT).

### BACKGROUND

In the field of multichannel spatial audio coding the two following challenges will most likely become more prominent in the future: (i) the processing an input audio signal with an arbitrary number of recorded audio channels and (ii) the handling of a plurality of arbitrarily placed microphones, in particular with respect to angles. One reason for this development is the current trend of providing more and more advanced audio recording devices, such as the Eigenmike. Moreover, another current trend is the use of various conventional recording devices at the same time for producing a multichannel audio signal. Thus, there is a need for a generic audio coding scheme that is able to meet the challenges mentioned above.

Currently, activities in multichannel audio coding for streaming and storage purposes are gaining popularity due to the many possible new applications in the field of immersive sound, such as applications for cinemas, virtual reality, telepresence and the like. Exemplary current multichannel audio codecs are Dolby Atmos using a multichannel object based coding, MPEG-H 3D Audio, which incorporates channel objects and Ambisonics-based coding. These current existing multichannel codecs, however, are still limited to some specific numbers of audio channel, such as 5.1, 7.1 or 22.2 channels, as required by industrial standards, such as ITU-R BS.2159-4.

An approach for processing an input audio signal with an arbitrary number of recorded audio channels is based on the Karhunen-Loève Transform (KLT), as disclosed in Yang et al., “High-Fidelity Multichannel Audio Coding with Karhunen-Loève Transform”, IEEE Trans. on Speech and Audio Proc., Vol. 11, No. 4, July 2003. Conventional KLT-based audio coding approaches have the drawback that generally a high metadata bitrate is required for allowing reconstructing the original audio signal with a sufficient perceptual quality on the basis of the compressed audio signal. This is because there is a trade-off between the audio quality and the metadata bitrate, wherein a higher metadata bitrate implies a better audio quality and vice versa. Thus, lowering the metadata bitrate will eventually affect the compressed audio quality.

Thus, there is a need for an improved KLT-based apparatus and method for encoding an multichannel audio signal, which in comparison to conventional apparatuses and methods provides an improved audio quality for similar or lower metadata bitrates.

### SUMMARY

It is an object of the invention to provide an improved KLT-based apparatus and method for encoding a multichannel audio signal, which in comparison to conventional apparatuses and methods provides an improved audio quality for similar or lower metadata bitrates.

The foregoing and other objects are achieved by the subject matter of the independent claims. Further implementation forms are apparent from the dependent claims, the description and the figures.

According to a first aspect the invention relates to an apparatus for encoding an input audio signal, wherein the input audio signal is a multichannel audio signal, i.e. comprises a plurality of input audio channels. The apparatus comprises a pre-processor based on the Karhunen-Loève transformation (KLT), i.e. a KLT-based pre-processor. The KLT-based pre-processor is configured to transform the plurality of input audio channels into a plurality of eigenchannels and to provide metadata associated with the plurality of eigenchannels, wherein the metadata allows reconstructing the plurality of input audio channels on the basis of the plurality of eigenchannels. The apparatus further comprises an eigenchannel encoder configured to encode a subset of the plurality of eigenchannels, and a metadata encoding unit configured to encode the metadata and to provide the metadata in a quantized form. The metadata encoding unit is configured to feed the metadata in the quantized form back to the KLT-based pre-processor and the KLT-based pre-processor is configured to transform the plurality of input audio channels into the plurality of eigenchannels on the basis of the metadata in the quantized form.

In a first implementation form of the apparatus according to the first aspect as such, the metadata comprises one or more of: a covariance matrix of the plurality of input audio channels and an eigenvector of the covariance matrix.

In a second implementation form of the apparatus according to the first aspect as such or its first implementation form, the metadata encoding unit comprises a metadata encoder and a metadata decoder, wherein the metadata encoder is configured to encode the metadata and wherein the metadata decoder is configured to provide the metadata in the quantized form by decoding the encoded metadata.

In a third implementation form of the apparatus according to the first aspect as such or its first implementation form, the metadata encoding unit comprises a metadata encoder, wherein the metadata encoder is configured to encode the metadata and to provide the metadata in the quantized form.

In a fourth implementation form of the apparatus according to the first aspect as such or any one of the first to third implementation form thereof, the metadata encoding unit is a lossy encoding unit.

In a fifth implementation form of the apparatus according to the first aspect as such or any one of the first to fourth implementation form thereof, wherein the KLT-based pre-processor is configured to transform the plurality of input audio channels into the plurality of eigenchannels on the basis of the metadata in the quantized form by performing a matrix multiplication.

In a sixth implementation form of the apparatus according to the first aspect as such or any one of the first to fifth implementation form thereof, the input audio signal comprises a plurality of frequency bands and the apparatus is configured to encode the input audio signal separately in the different frequency bands.

In a seventh implementation form of the apparatus according to the first aspect as such or any one of the first to sixth implementation form thereof, the KLT-based pre-processor is configured to transform the plurality of input audio channels into the plurality of eigenchannels on the basis of the metadata in the quantized form by optimizing a perceptual performance measure.

In an eighth implementation form of the apparatus according to the first aspect as such or any one of the first to seventh implementation form thereof, the apparatus is configured to encode the input audio signal in a frame-wise manner and the metadata encoding unit is configured to encode the metadata only every N-th frame, wherein N is an integer greater than 1.

According to the second aspect the invention relates to a method for encoding an input audio signal, wherein the input audio signal comprises a plurality of input audio channels. The method comprises providing by a KLT-based pre-processor, which is configured to transform the plurality of input audio channels into a plurality of eigenchannels, metadata associated with the plurality of eigenchannels, wherein the metadata allows reconstructing the plurality of input audio channels on the basis of the plurality of eigenchannels, encoding the metadata and providing the metadata in a quantized form, feeding the metadata in the quantized form back to the KLT-based pre-processor, transforming the plurality of input audio channels into the plurality of eigenchannels on the basis of the metadata in the quantized form, and encoding a subset of the plurality of eigenchannels.

The encoding method according to the second aspect of the invention can be performed by the encoding apparatus according to the first aspect of the invention. Further features of the encoding method according to the second aspect of the invention result directly from the functionality of the encoding apparatus according to the first aspect of the invention and its different implementation forms.

According to a third aspect the invention relates to a computer program comprising program code for performing the encoding method according to the second aspect of the invention when executed on a computer.

The invention can be implemented in hardware and/or software.

### BRIEF DESCRIPTION OF THE DRAWINGS

Further embodiments of the invention will be described with respect to the following figures, wherein:

FIG. 1 shows a schematic diagram of a conventional KLT-based audio coding system including an encoding apparatus and a decoding apparatus;

FIG. 2 shows a schematic diagram of a KLT-based audio coding system including an encoding apparatus according to an embodiment;

FIG. 3 shows a schematic diagram of a KLT-based audio coding system including an encoding apparatus according to another embodiment; and

FIG. 4 shows a schematic diagram illustrating a method for encoding a multichannel audio signal according to an embodiment.

In the various figures, identical reference signs will be used for identical or at least functionally equivalent features.

### DETAILED DESCRIPTION OF EMBODIMENTS

In the following description, reference is made to the accompanying drawings, which form part of the disclosure, and in which are shown, by way of illustration, specific aspects in which the invention may be placed. It will be appreciated that the invention may be placed in other aspects and that structural or logical changes may be made without departing from the scope of the invention. The following detailed description, therefore, is not to be taken in a limiting sense, as the scope of the invention is defined by the appended claims.

For instance, it will be appreciated that a disclosure in connection with a described method will generally also hold true for a corresponding device or system configured to perform the method and vice versa. For example, if a specific method step is described, a corresponding device may include a unit to perform the described method step, even if such unit is not explicitly described or illustrated in the figures.

Moreover, in the following detailed description as well as in the claims, embodiments with functional blocks or processing units are described, which are connected with each other or exchange signals. It will be appreciated that the invention also covers embodiments which include additional functional blocks or processing units that are arranged between the functional blocks or processing units of the embodiments described below.

Finally, it is understood that the features of the various exemplary aspects described herein may be combined with each other, unless specifically noted otherwise.

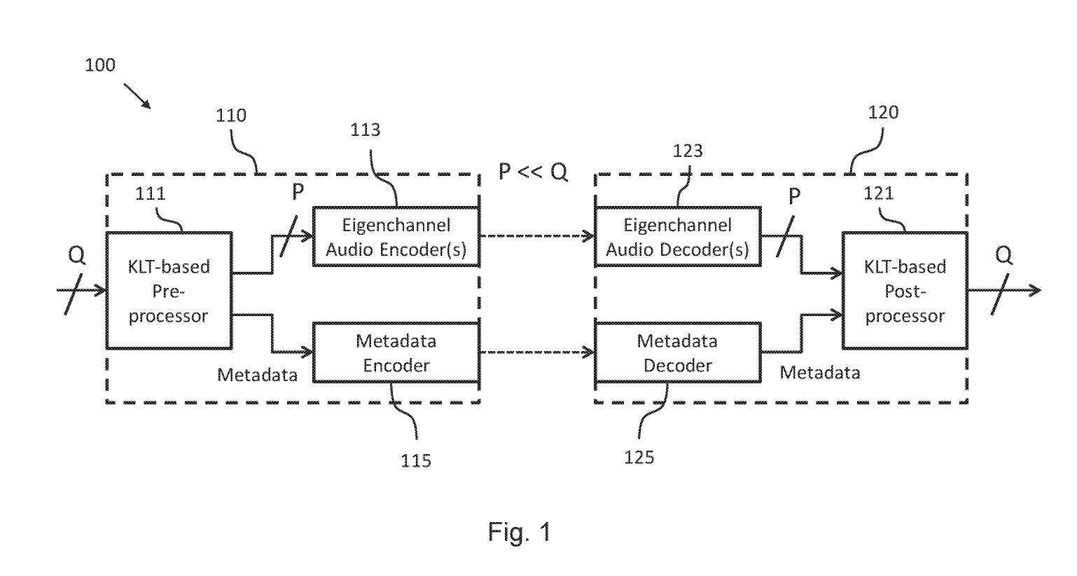

FIG. 1 shows a schematic diagram of a conventional audio coding system 100 comprising an apparatus 110 for encoding a multichannel audio signal and an apparatus 120 for decoding the encoded multichannel audio signal. The encoding apparatus 110 and the decoding apparatus 120 implement a KLT-based audio coding approach. Further details about this approach are described in Yang et al., “High-Fidelity Multichannel Audio Coding with Karhunen-Loève Transform”, IEEE Trans. on Speech and Audio Proc., Vol. 11, No. 4, July 2003, which is hereby incorporated by reference in its entirety.

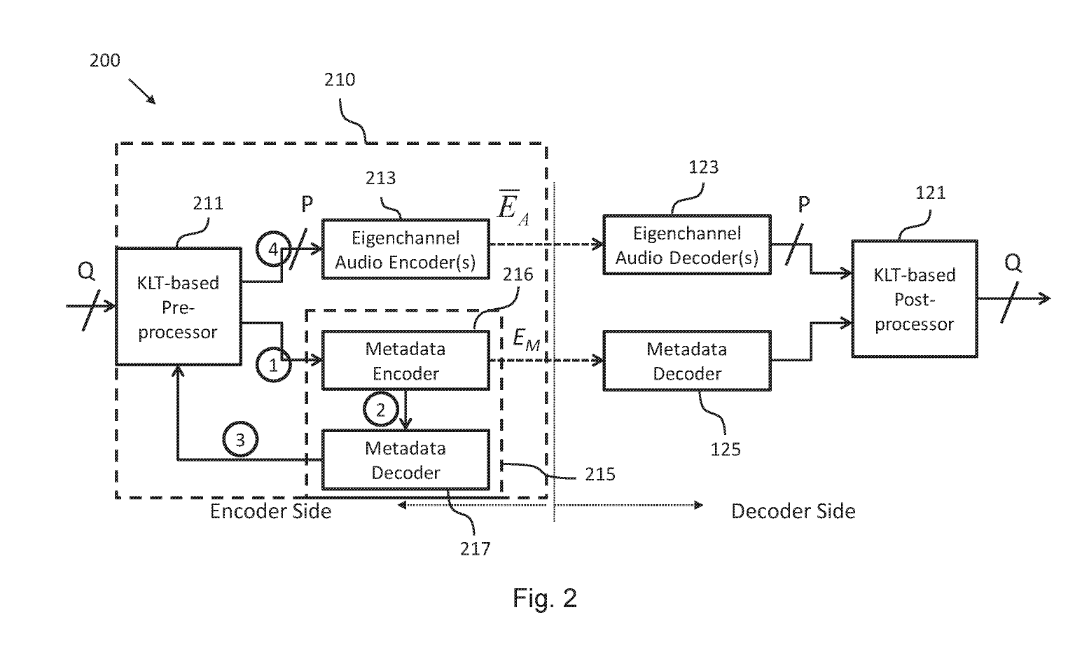

FIG. 2 shows a schematic diagram of a KLT-based audio coding system 200 including an encoding apparatus 210 according to an embodiment. The apparatus 210 is configured to encode an input audio signal having Q input audio channels. To this end, the encoding apparatus 210 comprises a KLT-based pre-processor 211 configured to transform the Q input audio channels into P eigenchannels (also referred to as transform coefficients) and to provide metadata associated with the P eigenchannels, which allows reconstructing the Q input audio channels on the basis of the P eigenchannels. The number of P-channels is expected to be much lower than Q.

Moreover, the encoding apparatus 210 comprises an eigenchannel encoder 213 configured to encode the P eigenchannels and a metadata encoding unit 215 configured to encode the metadata and to provide the metadata in a quantized form. The metadata encoding unit 215 is configured to feed the metadata in the quantized form back to the KLT-based pre-processor 211. The KLT-based pre-processor 211 is configured to transform the plurality of input audio channels into the plurality of eigenchannels on the basis of the metadata in the quantized form. Accordingly, the KLT-based pre-processor 211 is enabled to use the metadata in the quantized form rather than the original, unquantized metadata to transform the plurality of input audio channels into the plurality of eigenchannels. This improves the coding accuracy. Therefore a higher compression ratio can be achieved for a given desired audio quality level of the compressed audio, or the audio quality can be improved for a given compression ratio or bitrate of the compressed audio. In short, the compression scheme is improved.

In an embodiment, the metadata comprises the covariance matrix of the plurality of input audio channels or at least the non-redundant elements thereof and/or the eigenvectors of the covariance matrix.

As will be appreciated, the encoding apparatus 210 implements a kind of serial or staged encoding process, as has been indicated in FIG. 2 by the four stages identified by the encircled numerals 1 to 4.

In stage 1 the metadata provided by the KLT-based pre-processor 211 is fed to the metadata encoding unit 215. In the embodiment shown in FIG. 2 the metadata encoding unit 215 comprises a metadata encoder 216 and a metadata decoder 217. The metadata encoder 216 provides a metadata bitstream, which is ready to be stored or transmitted to the metadata decoder 125 of the decoding apparatus 120.

In stage 2 the metadata bitstream is fed to the metadata decoder 217, which outputs in response thereto the metadata in a quantized form.

In stage 3 the metadata in the quantized form is fed back to the KLT-based pre-processor 211.

In stage 4 the KLT-based pre-processor 211 transforms the Q input audio channels into the P eigenchannels on the basis of the metadata in the quantized form provided by the metadata decoder 217. In an embodiment, the KLT-based pre-processor 211 is configured to transform the Q input audio channels into the P eigenchannels on the basis of the metadata in the quantized form by performing a matrix multiplication based on the covariance matrix. The KLT-based pre-processor 211 is configured to provide these P eigenchannels, which have been obtained on the basis of the original Q input audio channels and the quantized metadata, to the eigenchannel encoder 213.

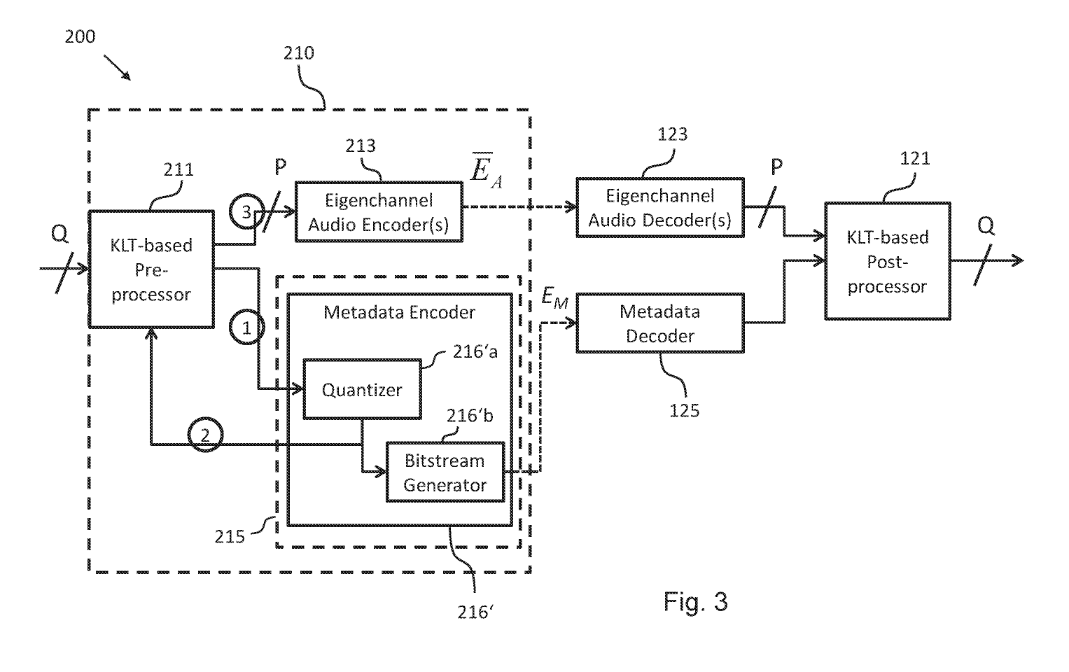

FIG. 3 shows a schematic diagram of the KLT-based audio coding system 200 including the encoding apparatus 210 according to another embodiment. The encoding apparatus 210 shown in FIG. 3 differs from the encoding apparatus 210 shown in FIG. 2 in that the metadata encoding unit 215 comprises a modified metadata encoder 216′, which is configured to encode the metadata and to provide the metadata in the quantized form. To this end, the modified metadata encoder 216′ of the encoding apparatus 210 shown in FIG. 3 comprises a quantizer 216′a and a bitstream generator 216′b. In other words, in the embodiment shown in FIG. 3 the quantized metadata is a byproduct of the metadata encoding process without the need for a metadata decoder.

The innovation allows providing a synergistic effect between the metadata encoding unit 215 and the eigenchannel encoder 213, which allows for an improved error compensation mechanism at the encoder side. This is because the invention shifts the quantization error, which cannot be masked perceptually by the metadata encoding unit 215, to the P eigenchannels, which can be considered as audio channels and processed in an error correcting manner using a perceptual auditory mask. Thus, in an embodiment, the KLT-based pre-processor 211 is configured to transform the plurality of input audio channels into the plurality of eigenchannels on the basis of the metadata in the quantized form by optimizing a perceptual performance measure. Moreover, in an embodiment, the metadata encoding unit 215 is a lossy encoding unit.

In an embodiment, the input audio signal comprises a plurality of frequency bands and the encoding apparatus 210 is configured to encode the input audio signal separately in the different frequency bands.

In an embodiment, the encoding apparatus 210 is configured to encode the input audio signal in a frame-wise manner and the metadata encoding unit 215 is configured to encode the metadata only every N-th frame, wherein N is an integer greater than 1.

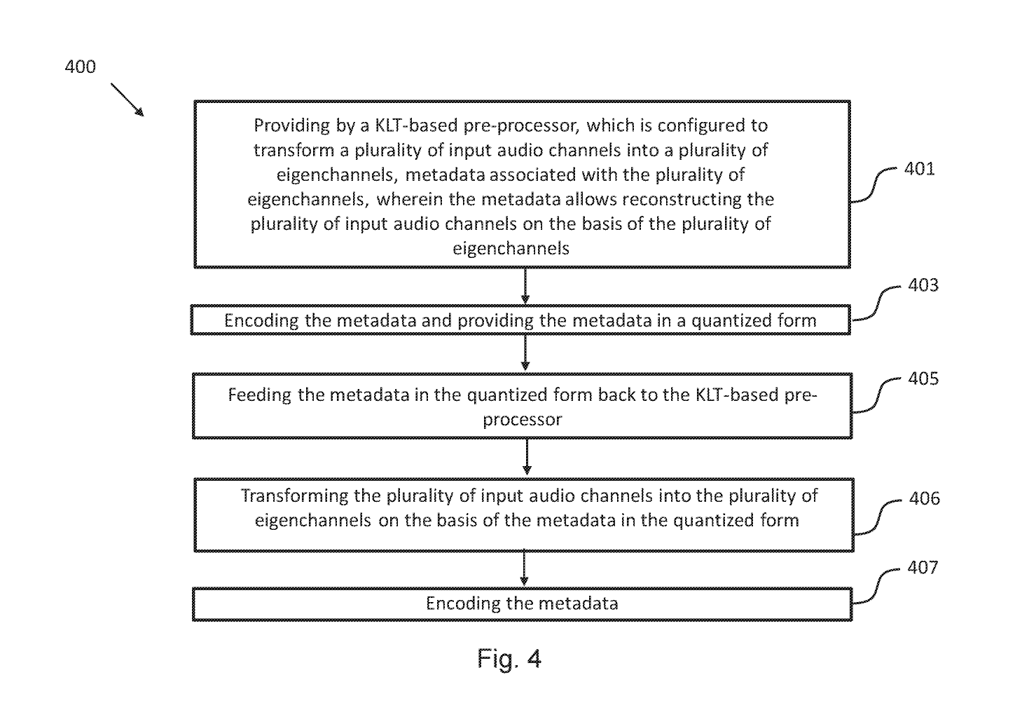

FIG. 4 shows a schematic diagram illustrating a method 400 for encoding a multichannel audio signal according to an embodiment. The method 400 comprises the following steps: providing 401 by the KLT-based pre-processor 211, which is configured to transform the plurality of input audio channels into a plurality of eigenchannels, metadata associated with the plurality of eigenchannels, wherein the metadata allows reconstructing the plurality of input audio channels on the basis of the plurality of eigenchannels, encoding 403 the metadata and providing the metadata in a quantized form, feeding 405 the metadata in the quantized form back to the KLT-based pre-processor 211, transforming 406 the plurality of input audio channels into the plurality of eigenchannels on the basis of the metadata in the quantized form; and encoding 407 a subset of the plurality of eigenchannels.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the invention beyond those described herein. While the invention has been described with reference to one or more particular embodiments, those skilled in the art recognize that many changes may be made thereto without departing from the scope of the invention. It is therefore to be understood that within the scope of the appended claims and their equivalents, the invention may be practiced otherwise than as specifically described herein.

What is claimed is:

1. An apparatus for encoding an input audio signal, the input audio signal comprising a plurality of input audio channels, the apparatus comprising:
a Karhunen-Loève Transform (KLT)-based pre-processor configured to transform the plurality of input audio channels into a plurality of eigenchannels and to provide metadata associated with the plurality of eigenchannels, wherein the metadata allows reconstructing the plurality of input audio channels on the basis of the plurality of eigenchannels;
an eigenchannel encoder configured to encode a subset of the plurality of eigenchannels; and
a metadata encoding unit configured to encode the metadata, to provide the metadata in a quantized form, and to feed the metadata in the quantized form back to the KLT-based pre-processor, and wherein the KLT-based pre-processor is further configured to transform the plurality of input audio channels into the plurality of eigenchannels on the basis of the metadata in the quantized form.

2. The apparatus of claim 1, wherein the metadata comprises one or more of:
a covariance matrix of the plurality of input audio channels and an eigenvector of the covariance matrix.

3. The apparatus of claim 1, wherein the metadata encoding unit comprises a metadata encoder and a metadata decoder, wherein the metadata encoder is configured to encode the metadata, and wherein the metadata decoder is configured to provide the metadata in the quantized form by decoding the encoded metadata.

4. The apparatus of claim 1, wherein the metadata encoding unit comprises a metadata encoder, wherein the metadata encoder is configured to encode the metadata and to provide the metadata in the quantized form.

5. The apparatus of claim 1, wherein the metadata encoding unit is a lossy encoding unit.

6. The apparatus of claim 1, wherein the KLT-based pre-processor is configured to transform the plurality of input audio channels into the plurality of eigenchannels on the basis of the metadata in the quantized form by performing a matrix multiplication.

7. The apparatus of claim 1, wherein the input audio signal comprises a plurality of frequency bands and wherein the apparatus is configured to encode the input audio signal separately in the different frequency bands.

8. The apparatus of claim 1, wherein the KLT-based pre-processor is configured to transform the plurality of input audio channels into the plurality of eigenchannels on the basis of the metadata in the quantized form by optimizing a perceptual performance measure.

9. The apparatus of claim 1, wherein the apparatus is configured to encode the input audio signal in a frame-wise manner and wherein the metadata encoding unit is configured to encode the metadata only every N-th frame, wherein N is an integer greater than 1.

10. A method for encoding an input audio signal, the input audio signal comprising a plurality of input audio channels, the method comprising:
providing by a Karhunen-Loève Transform (KLT)-based pre-processor, metadata associated with the plurality of eigenchannels, wherein the metadata allows reconstructing the plurality of input audio channels on the basis of the plurality of eigenchannels;
encoding the metadata and providing the metadata in a quantized form;
feeding the metadata in the quantized form back to the KLT-based pre-processor;
transforming the plurality of input audio channels into the plurality of eigenchannels on the basis of the metadata in the quantized form; and
encoding a subset of the plurality of eigenchannels.

11. A non-transitory computer-readable medium carrying a computer-executable program code, wherein the program code, when executed on a computer, causes the computer to perform a method including:
providing, metadata associated with the plurality of eigenchannels, wherein the metadata allows reconstructing the plurality of input audio channels on the basis of the plurality of eigenchannels;
encoding the metadata and providing the metadata in a quantized form;
feeding the metadata in the quantized form back to the KLT-based pre-processor;
transforming the plurality of input audio channels into the plurality of eigenchannels on the basis of the metadata in the quantized form; and
encoding a subset of the plurality of eigenchannels.

12. The method of claim 10, wherein the metadata comprises one or more of:
a covariance matrix of the plurality of input audio channels and an eigenvector of the covariance matrix.

13. The method of claim 10, wherein providing the metadata in the quantized form comprises decoding the encoded metadata.

14. The method of claim 10, wherein transforming the plurality of input audio channels into the plurality of eigenchannels on the basis of the metadata in the quantized form comprises: performing a matrix multiplication.

15. The method of claim 10, wherein the input audio signal comprises a plurality of frequency bands, and wherein the method comprises: encoding the input audio signal separately in the different frequency bands.

16. The method of claim 10, wherein transforming the plurality of input audio channels into the plurality of eigenchannels on the basis of the metadata in the quantized form comprises: optimizing a perceptual performance measure.

17. The method of claim 10, further comprising:
encoding the input audio signal in a frame-wise manner; and
encoding the metadata only every N-th frame, wherein N is an integer greater than 1.

18. The non-transitory computer-readable medium of claim 11, wherein the metadata comprises one or more of:
a covariance matrix of the plurality of input audio channels and an eigenvector of the covariance matrix.

19. The non-transitory computer-readable medium of claim 11, wherein providing the metadata in the quantized form comprises decoding the encoded metadata.

20. The non-transitory computer-readable medium of claim 11, wherein transforming the plurality of input audio channels into the plurality of eigenchannels on the basis of the metadata in the quantized form comprises: performing a matrix multiplication.
